(19) United States
(12) Patent Application Publication
(10) Pub. No.: US 2013/0312862 A1
(43) Pub. Date: Nov. 28, 2013

(54) SPOOLABLE PIPE WITH INCREASED COMPRESSIVE STRENGTH AND METHOD OF MANUFACTURE

(71) Applicants: Mark Douglas Kalman, Luthersville, GA (US); Liang Yu, Katy, TX (US); Duane Glenn Moosberg, Wilmington, DE (US); David Michael McCall, Rosenberg, TX (US); Michael Alan Seymour, Katy, TX (US)

(72) Inventors: Mark Douglas Kalman, Luthersville, GA (US); Liang Yu, Katy, TX (US); Duane Glenn Moosberg, Wilmington, DE (US); David Michael McCall, Rosenberg, TX (US); Michael Alan Seymour, Katy, TX (US)

(73) Assignee: DEEPFLEX INC., Houston, TX (US)

(21) Appl. No.: 13/994,575

(22) PCT Filed: Apr. 19, 2011
(86) PCT No.: PCT/US2011/032988

§ 371 Date: Aug. 13, 2013

Related U.S. Application Data
(60) Provisional application No. 61/422,922, filed on Dec. 14, 2010.

(51) Int. Cl. F16L 11/08; B32B 38/00

(52) U.S. Cl. CPC F16L 11/08; B32B 38/0012
USPC 138/125; 156/187; 156/60

(57) ABSTRACT

In one aspect, the present disclosure relates to a method to manufacture an armor layer of a spoolable pipe. The method includes forming one or more laminates and wrapping the one or more laminates onto an underlying layer of the pipe. At least one of the laminates is composed of at least one reinforcement tape and at least one fabric tape. The laminates may be bonded to an adjacent laminate, thereby forming a reinforcement stack. In another aspect, the present disclosure relates to a method to manufacture an armor layer of a spoolable pipe. The method includes providing a plurality of reinforcement tapes having fibers oriented in a first direction and disposing at least one fabric tape between at least two layers of the plurality of reinforcement tapes. The fibers of the at least one fabric tape may be oriented in at least a second direction.

### CROSS-REFERENCE TO RELATED APPLICATIONS

The present application claims priority from U.S. Provisional Patent Application 61/422,922, filed Dec. 14, 2010. The contents of the priority application are hereby incorporated by reference in their entirety.

### BACKGROUND

1. Field of the Disclosure

The present disclosure relates to a spoolable pipe and method of manufacture. Specifically, increased strength is provided in armor layers of a spoolable pipe structure.

2. Description of the Related Art

Spoolable pipe, such as flexible fiber-reinforced pipe is used in natural resource deposit extraction. For example, one type of spoolable pipe is unbonded flexible fiber-reinforced pipes that may be made with reinforcement stacks composed of fiber-reinforced composite tape and applied to form armor layers for the spoolable pipe. Inter-laminar adhesive may be applied to surfaces of the tapes to allow for bonding between the tapes to form a reinforcement stack of the armor layer. After application of the adhesive, the reinforcement stack may be helically wrapped on a pipe and heated or subject to radiation, thereby allowing the inter-laminar adhesive to bond and strengthen the reinforcement stack. The tape of the reinforcement stack may be a unidirectional fibrous tape, providing high longitudinal strength to the stack, and, therefore, to the armor layer.

Examples of tapes and tape stacks used in spoolable pipe are described in U.S. Pat. No. 6,491,779 issued to Michael J. Bryant, on Dec. 10, 2002 and entitled “Method of Forming a Composite Tubular Assembly,” U.S. Pat. No. 6,804,942 issued to Michael J. Bryant, on Oct. 19, 2004 and entitled “Composite Tubular Assembly and Method of Forming Same,” and U.S. Pat. No. 7,073,978 issued to Michael J. Bryant, on Jul. 11, 2006 and entitled “Lightweight Catenary System,” each incorporated by reference in its entirety herein.

### SUMMARY OF CLAIMED SUBJECT MATTER

In one aspect, the present disclosure relates to a method to manufacture an armor layer of a spoolable pipe. The method includes forming one or more laminates and wrapping the one or more laminates onto an underlying layer of the pipe. The one or more laminates are composed of at least one reinforcement tape and at least one fabric tape. The laminates may be bonded to an adjacent laminate, thereby forming a reinforcement stack.

In another aspect, the present disclosure relates to a method to manufacture an armor layer of a spoolable pipe. The method includes providing a plurality of reinforcement tapes having fibers oriented in a first direction and disposing at least one fabric tape between at least two layers of the plurality of reinforcement tapes. The fibers of the at least one fabric tape may be oriented in at least a second direction.

In another aspect, the present disclosure relates to an armor layer of a spoolable pipe. The armor layer includes a plurality of reinforcement tapes having fibers oriented in a first direction and at least one fabric tape disposed between at least two tapes of the plurality of reinforcement tapes. The at least one fabric tape comprises fibers oriented in at least a second direction.

In another aspect, the present disclosure relates to an armor layer of a spoolable pipe. The armor layer includes a plurality of reinforcement tapes comprising fibers oriented in a first direction, in which at least one of the plurality of reinforcement tapes comprises a plurality of fibers woven within the at least one reinforcement tape. The woven fibers of the at least one reinforcement tape are oriented in at least a second direction.

In another aspect, the present disclosure relates to a method to manufacture an armor layer of a spoolable pipe. The method includes providing a plurality of reinforcement tapes having fibers oriented in a first direction and interweaving a plurality of fibers within at least one of the plurality of reinforcement tapes in a second direction.

### BRIEF DESCRIPTION OF DRAWINGS

FIG. 1A is an isometric view of a spoolable pipe in accordance with one or more embodiments of the present disclosure.

FIG. 1B is a cross-sectional view of a spoolable pipe in accordance with one or more embodiments of the present disclosure.

FIG. 2 is a schematic of forming laminates in accordance with one or more embodiments of the present disclosure.

FIG. 3 is a process of forming laminates in accordance with one or more embodiments of the present disclosure.

FIG. 4 shows a schematic of a cassette in accordance with one or more embodiments of the present disclosure.

FIG. 5 is a schematic of a primary winder in accordance with one or more embodiments of the present disclosure.

FIG. 6 is a process of forming a spoolable pipe in accordance with one or more embodiments of the present disclosure.

FIG. 7 is a schematic view of a bonding apparatus in accordance with one or more embodiments of the present disclosure.

FIG. 8 is a schematic view of an alternate bonding apparatus in accordance with one or more embodiments of the present disclosure.

FIG. 9 is a plot of fiber failure criterion for the design of a reinforcement stack.

FIG. 10 is a finite element model of reinforcement stacks.

FIG. 11 is a plot of fiber failure criterion of reinforcement stacks in accordance with one or more embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

In view of the above, reinforcement stacks of an armor layer of a spoolable pipe with improved strength are provided herein. Spoolable pipe, for example, flexible pipe, such as unbonded Flexible Fiber Reinforced Pipe (FFRP®) as developed by DeepFlex, Inc., may be constructed from extruded polymer fluid barrier layers and metallic or composite armor layers. The unique design of bonding multiple thin reinforcement tapes or laminates to form reinforcement stacks with interlaminar adhesive allows the reinforcement material to provide resistance to internal and external pressure and axial tension and compression loads experienced by the spoolable pipe. The higher axial compression capacity of the flexible pipe structure laminated reinforcement stack may overcome challenges faced in previous composite armored flexible pipe designs which employ multiple thin fiber reinforced polymer tapes. Although discussed herein with respect to a flexible pipe of the structure described, those skilled in the art will appreciate that embodiments are not limited thereto, and embodiments disclosed herein may be applied to any spoolable pipe known in the art including pipes with an internal carcass.

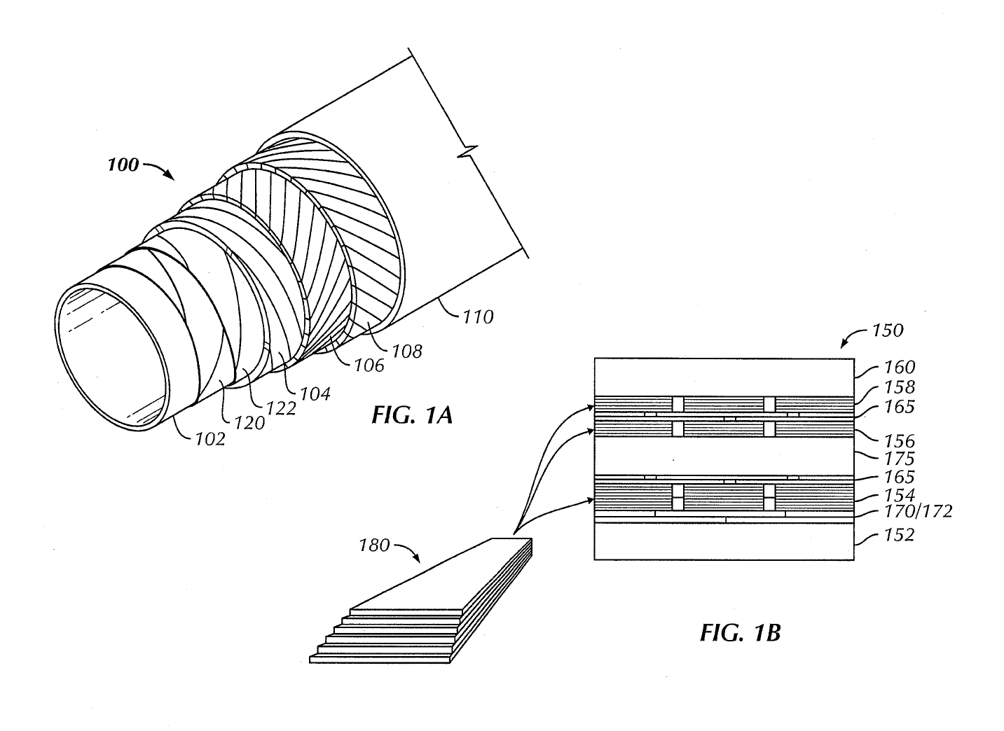

Referring initially to FIG. 1A, an isometric view of a spoolable pipe 100 is shown. A liner 102 may be wrapped with one or more armor layers and additional structural and/or functional layers. For example, armor layer 106, composed of reinforcement stacks comprising stacks of laminates helically wrapped in a first orientation, and armor layer 108, composed of reinforcement stacks comprising stacks of laminates helically wrapped in a second orientation, may be provided as structural layers of pipe 100. Further, one or more armor layers 104, composed of helically wrapped reinforcement stacks comprising stacks of laminates, may be wrapped at different, for example higher, lay-angles to form additional armor layers with different functional characteristics. Anti-wear layers (not shown) may be disposed between armor layers 104, 106, and 108 and one or more anti-extrusion layers 120 and 122 may be disposed between inner most armor layer 104 and liner 102. A jacket 110 may cover the armor layers and other elements of the pipe 100 to provide external protection.

Referring now to FIG. 1B, a cross-sectional view of a spoolable pipe 150 is shown. A liner 152 may be wrapped with one or more armor layers and additional structural and/or functional layers. For example, armor layers 154, 156, and 158 may be provided as structural layers of pipe 150. Armor layers 154, 156, and 158 may be composed of stacks of laminates and/or tape 180. Anti-wear layers 165 may be disposed between armor layers 156 and 158 and/or between armor layer 154 and a membrane 175. Further, one or more anti-extrusion layers 170 and 172 may be disposed between inner most armor layer 154 and liner 152. A jacket 160 may cover the armor layers and other elements of the pipe 150 to provide external protection.

Although FIGS. 1A and 1B depict pipe structures 100 and 150 of a spoolable pipe, these are merely for example only, and those skilled in the art will appreciate that a spoolable pipe may include additional and/or different layers, without departing from the scope of the present disclosure. For example, a spoolable pipe structure may include various combinations of liners, carcasses, hoop-strength or pressure armor layers, anti-wear layers, lubricating layers, tensile armor layers, anti-extrusion layers, membranes, and/or any other layers as may be included in a spoolable and/or flexible pipe, without departing from the scope of the present disclosure.

Referring again to FIG. 1A, armor layers 104, 106, 108 may provide various structural protection and/or strength to spoolable pipe 100. For example, the reinforcement stacks of armor layer 104 may be configured and oriented to form a hoop-strength armor layer and the reinforcement stacks of armor layers 106 and 108 may be configured and oriented to form tensile armor layers. Generally, as used herein, an armor layer may be a tensile armor layer, a hoop-strength armor layer, or other reinforcement and/or structural armor layer of a spoolable or flexible pipe and may be composed of one or more stacks of laminates and/or reinforcement tape, as discussed hereinafter.

The reinforcement stacks of armor layers 104, 106, and 108 may be composed of stacks of laminates. The laminates may be made of one or more stacked fiber-reinforced tapes (reinforcement tapes) that may be laminated and bonded together with an interlaminate layer or tape or may be a single structural member. The reinforcement tapes of the laminates may be unidirectional tape and/or other structural and/or reinforced tape. The reinforcement tape may include unidirectional, longitudinally, oriented fibers, providing strength in the longitudinal direction of the tape. The individual reinforcement tapes may be composed of the unidirectional fibers laminated, or bonded, by a material, such as a matrix material, that may provide strength in the width direction of the stack, thereby increasing the compressive capacity of the reinforcement tape.

The laminates or reinforcement tapes may be formed from fibers encapsulated in polymers, and bonding between adjacent laminates in a reinforcement stack may require heat, radiation, or normal force to bond the laminates to adjacently stacked laminates to achieve appropriate operational properties. For example, the reinforcement stacks may be chemically resistant, thermally insulated, strong enough to provide support, flexible enough to provide relative movement and/or sliding, flexible enough to allow the pipe to bend, and/or configured to any other necessary and/or required operational properties.

As noted, the laminates may be fiber-reinforced tapes. The laminates may be composed of composite matrix materials and/or polymers, including, but not limited to polyphenylene sulfide, polyetheretherketone, polyvinylidene halide, vinyl halide polymer, vinyl halide copolymer, polyvinyl ketone, polyvinyl ether, vinyl ester, hybrid epoxy vinyl ester, polyvinyl methyl ether, polyvinyl aromatic, silicone, acrylic polymer, acrylic copolymer, polybutylmethacrylate, polyacrylonitrile, acrylonitrile-styrene copolymer, ethylene-methyl methacrylate copolymer, polyamide, polyimide, polyether, polyhedral oligomeric silsesquioxane epoxy hybrid, epoxy resin, polyurethane, and/or polyoxymethylene and/or combinations thereof. The composite matrix materials and/or polymers that compose the fiber reinforced tapes may be partially or fully cured or hardened. As formed from the fiber reinforced tapes, the fibers of the laminate may be unidirectional in orientation, allowing for maximum longitudinal strength when a reinforcement stack is formed. Laminates with unidirectional fibers may be formed using a pultrusion process. Additionally, the fibers of the fiber reinforced tapes may be made of materials such as aramids, aromatics, ceramics, polyolefin, carbon fiber, graphite fiber, fiberglass, E-glass, chemical resistant E-glass, S-glass, metallic fibers, and/or any other fibrous material and/or any combinations thereof.

The laminates may be gathered, collected, and/or consolidated to form a reinforcement stack at the time of installation of the reinforcement stacks onto the surface of the pipe when forming an armor layer, or the laminates may be formed in segments and stored for later application onto a pipe structure. Further, application of a bonding material to bond adjacent laminates in a reinforcement stack, such as an inter-laminar adhesive, may be applied during the reinforcement stack forming and installation processes or during formation of a laminate. The bonding material may be any suitable thermoset or thermoplastic material that provides sufficient bonding strength to keep the laminates from delaminating in service. The bonding provided by the interlaminar adhesive may be reversible, such as described in U.S. Pat. No. 7,842,149 issued to Kristian Glejbøl, on Nov. 30, 2010 and entitled “Method of Manufacturing a Reinforcement Element for a Flexible Pipeline,” incorporated in its entirety herein by reference.

As used herein a laminate is a tape structure or element of a reinforcement stack. In particular a laminate may be a single reinforcement tape or may be a reinforcement tape with additional properties or elements within and/or attached thereto. For example, a laminate may be a modified reinforcement tape that includes cross-woven fibers, or weft fibers, that may be configured with the longitudinal fibers of the reinforcement tape prior to lamination of the fibers to form the tape. Alternatively, a laminate may be two tapes bonded together. For example, a laminate may be a reinforcement tape bonded with a fibrous tape in which the fibers of the fibrous tape may be configured at one or more different angles from the direction of the longitudinal fibers of the reinforcement tape. Alternatively still, a fabric tape may be bonded to a reinforcement tape to form a laminate. Moreover, laminates may be formed in any manner and incorporate any known elements without departing from the scope of the present disclosure. In accordance with one or more embodiments of the present disclosure, the fibers that are cross-woven, in the fibrous or fabric tape, may be substantially perpendicular to the fibers of the reinforcement tape. Although described herein as perpendicular, those skilled in the art will appreciate that the fibers of the cross-weave, fibrous tape, or fabric tape may be any angle or assortment of angles with respect to the fibers of the reinforcement tape, without departing from the scope of the present disclosure.

As noted, at the time of application to the pipe, the reinforcement stacks may be partially bonded. The tape layers that may form the laminates of the reinforcement stacks may be partially cured or hardened or fully cured or hardened at the time of applying the reinforcement stacks to the pipe. An inter-laminar adhesive may provide bonding between adjacent laminates stacked in the reinforcement stack, and may also provide additional strength to the reinforcement stack. As disclosed herein, one or more embodiments of the present disclosure may provide an increased compressive strength through application of an inter-laminar adhesive and a fiber tape with fibers oriented, at least, substantially perpendicular to the fibers of the reinforcement tape. According to one or more embodiments of the present disclosure, the reinforcement stacks may be formed by placing a fabric tape between each layer of reinforcement tape that may be collected (or stacked) to form the reinforcement stack. Alternatively, the fabric tape may be combined with a reinforcement tape to form a laminate of the reinforcement stack.

In one or more embodiments of the present disclosure, the bonding between adjacent reinforcement tapes may be provided by fabric tapes that may be interleaved with the reinforcement tapes. The interleaving may be completed by alternating fabric tapes with the reinforcement tapes, or multiple layers of fabric tape may be stacked between reinforcement tapes in any combination. The fabric tape may include glass, aramid, carbon, steel, or other non-metallic or metallic fibers, including those discussed above with respect to the reinforcement tapes, and may be a pre-impregnated tape (“prepreg”). As such, the fabric tape may provide both an inter-laminar adhesive and provide additional strength to the reinforcement stacks.

Prepreg tape, or prepreg, as used herein, is a pre-impregnated material having fibers distributed within or on a bonding matrix material. The fibers of the prepreg may be unidirectional, woven, non-woven, matt, chopped matt, random, or may have any other orientation of fibers. The fibers of the prepreg may be bonded by the matrix material and may also allow for a bonding process to bond the prepreg material with other elements, such as the reinforcement tapes. The matrix material may be asymmetrically distributed through the thickness of the prepreg so that it may be substantially tackier, or more adhesive, on one side than the other. The tackier side of the fabric tape may have a backer to prevent the adhesive from bonding to other elements or equipment during a manufacturing process and the backer may be removed when the fabric tape is to be bonded to or combined with another element, such as when forming a laminate. The less tacky side, or the side with no tack at all may not bond to adjacent material until the prepreg matrix material is activated by heat, radiation, or other process.

As noted above, the interleaved fabric tapes may be optimized for higher strength in the width direction rather than in the longitudinal direction or may be configured to provide strength both in the width direction and longitudinally. In accordance with one or more embodiments of the present disclosure, the longitudinal strength of a laminate may be provided by the unidirectional fibers of the reinforcement tape and the width direction strength may be provided by the fibers of the fabric tape.

Alternatively, as noted above, in accordance with one or more embodiments of the present disclosure, weft fibers may be woven with the longitudinal fibers prior to pultrusion of a resin onto the fibers during manufacture of the reinforcement tape, such that the reinforcement tapes may have strength in the width direction in addition to the longitudinal direction, obviating or reducing the requirement for the interleaved fabric tape.

Analyses have been conducted in accordance with DNV OS-C501 considering the Tsai-Wu fiber failure criteria under multi-axis stress loading to optimize and configure the interleaving of fabric within the laminates.

For example, in 3-D modeling:

$$\begin{matrix}{R}^{2} ( {F}_{11} {σ}_{1}^{2} + {F}_{22} {σ}_{2}^{2} + {F}_{33} {σ}_{3}^{2} + {F}_{12} {σ}_{12}^{2} + {F}_{13} {σ}_{13}^{2} + {F}_{23} {σ}_{23}^{2} ) + {R}^{2} ( 2 {H}_{12} {σ}_{1} {σ}_{2} + 2 {H}_{13} {σ}_{1} {σ}_{3} + 2 {H}_{23} {σ}_{2} {σ}_{3} ) + R ( {F}_{1} {σ}_{1} + {F}_{2} {σ}_{2} + {F}_{3} {σ}_{3} ) < 1 & ( Eq . 1 ) \\ and & \\ \begin{matrix} {F}_{ii} = \frac{1}{{\hat{σ}}_{it}^{2} {\hat{σ}}_{ic}^{2}} \\ {F}_{ii} = \frac{1}{{\hat{σ}}_{ij}^{2}} \\ {F}_{i} = \frac{1}{{\hat{σ}}_{it} {\hat{σ}}_{ic}} \\ {H}_{ij} = - 0.5 \sqrt{{F}_{ii} {F}_{jj}}\end{matrix} & ( Eq . 2 )\end{matrix}$$

where:

R is the safety factor;

σᵢᵢ is the normal stress in the i direction;

σᵢⱼ is the shear stress in the ij direction;

\hat{σ}ᵢₜ is the characteristic tensile strength in the i direction;

\hat{σ}_{ic} is the characteristic compressive strength in the i direction; and

\hat{σ}ᵢⱼ is the characteristic shear strength in the ij direction.

Simplifying to two dimensional loading, considering only the hoop and through thickness stresses (Tsai-Wu 2-D):

R²(F₁₁σ₁²+F₃₃σ₃²+F₁₃σ₁₃²+2H₁₃σ₁σ₃)+R(F₁σ₁+F₃σ₃)<1. (Eq. 3)

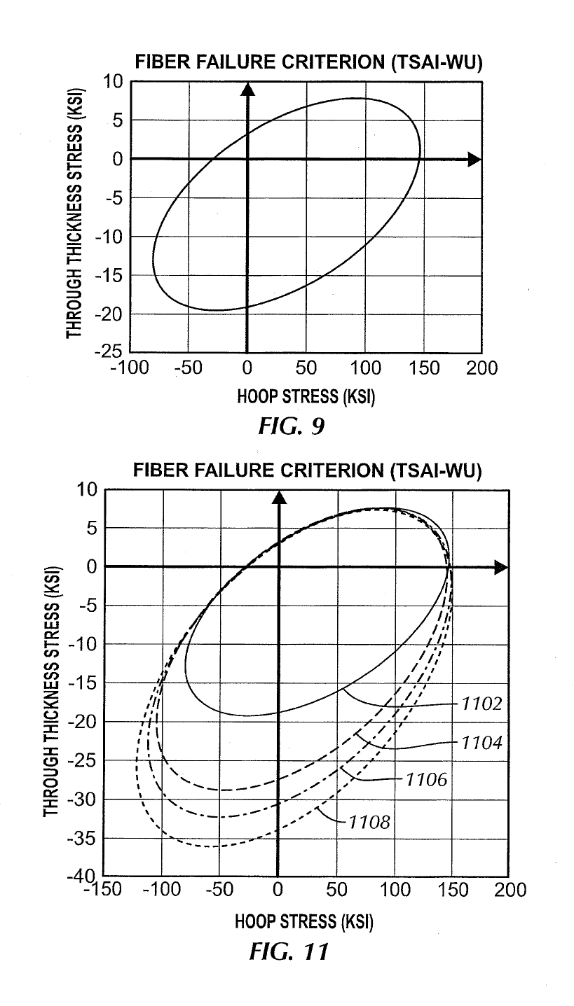

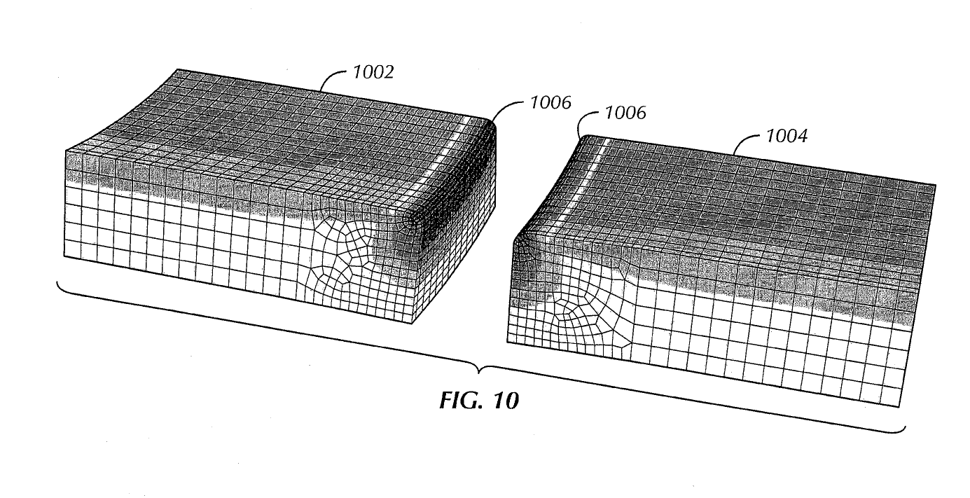

A typical failure envelope with unidirectional reinforcement tape without interleaved fabric, based on tensile strength in the circumferential (hoop) direction and compressive strength in the through thickness (radial) direction provides a failure envelope, as shown in FIG. 9, based on the 2-D Tsai-Wu failure theory. FIG. 10 illustrates typical finite element analysis results. In the example shown in FIG. 10, the through thickness compressive stress distribution on the stacks 1002 and 1004 at 10,000 psi internal pressure is shown. As shown in FIG. 10, a through thickness compressive stress distribution is shown at the highest concentration at the upper surface and corners 1006 of the two adjacent stacks 1002 and 1004.

Various tests conducted demonstrated that the model predicted the burst pressure and burst failure mode. One example test is a mid-scale test, where a pipe sample is built with the liner 102, the anti-extrusion layers 120 and 122, and hoop strength armor layer 104, as shown in FIG. 1A, only. An end cap load due to internal pressure, which is normally resisted by the tensile layers, is reacted against a test frame, so that the pipe does not extend axially. Dissection results after failure of the stacks of the armor layers indicated through thickness compressive failure of the reinforcement stack at the corner interfacing with the anti-extrusion layer, such as the high pressure areas 1006 shown in FIG. 10. Both the 2-D Tsai-Wu failure theory and finite element results compared favorably with the test results. In addition, finite element analysis has been conducted of the liner 102, anti-extrusion layers 120 and 122 and hoop reinforcement armor layer 104 to understand the stress state at the reinforcement stack corner/anti-extrusion layer interface.

Through thickness compression testing, small scale tests to simulate the multi-axis stress state loading, analysis and mid-scale testing optimization of the interleaving pattern and/or layer may be achieved. FIG. 11 illustrates how the Tsai-Wu failure envelope is expanded with use of embodiments of the present disclosure. FIG. 11 shows expansion of the Tsai-Wu failure envelope, demonstrating increase in burst pressure with the addition of interleaved fabric into the reinforcement stacks of the hoop strength armor layer.

In FIG. 11, the inner most envelope 1102 represents the failure envelope of a control minor layer, one having no interleaved fabric layer, similar to the failure envelope of FIG. 9. Envelope 1104 represents the failure envelope of a control layer with the addition of a fabric layer having a thickness of 0.01 inches (0.2540 mm) and comprising glass fibers. Envelope 1106 represents the failure envelope of a control layer with the addition of a fabric layer having a thickness of 0.014 inches (0.3356 mm) and comprising glass fibers. Envelope 1108 represents the failure envelope of a control layer with the addition of a fabric layer having a thickness of 0.01 inches (0.2540 mm) and comprising Kevlar fabric. Although shown with three examples of fabric, those skilled in the art will appreciate that FIGS. 9-11 merely represent testing of various embodiments of the present disclosure and that other compositions and dimensions of the fabric layer(s) may be used without departing from the present disclosure and/or may be used in other armor layers of a spoolable pipe.

Based on the results of the analyses and tests, it was determined that adding strength in the width direction of the stack would increase the compressive capacity, and therefore increase the burst pressure of the spoolable pipe. Accordingly, embodiments of the present disclosure provide increased strength across the width of the reinforcement stacks of the armor layers. Although the analysis presented herein demonstrates an increased strength in the hoop layer 104, similar analyses demonstrate improved performance of the tensile armor layer. For example, the improved stacks in accordance with one or more embodiments of the present disclosure may contribute to providing internal pressure load resistance, or may improve performance where contact pressure from adjacent layers is compressively loading the tensile armor in the through thickness direction. Thus, the advantages of the interleaved fabric layer, with fibers substantially perpendicular to the longitudinal fibers of the reinforcement tape, may apply to both the hoop armor layer 104 and the tensile armor layers 106 and 108. This is particularly true for high pressure and high tension capacity spoolable pipe designs that may be employed in deep water operations.

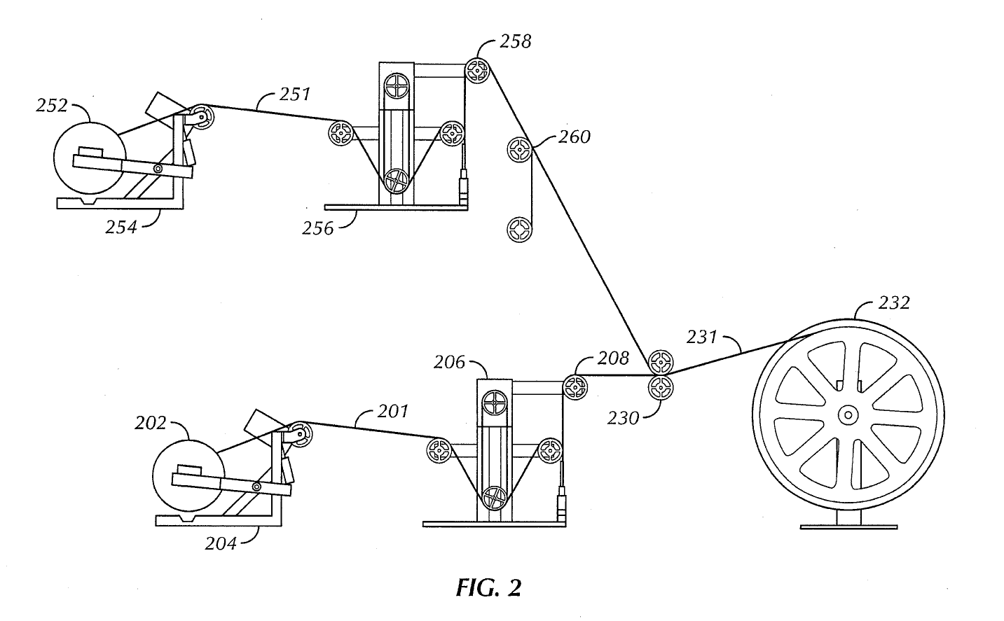

Now with reference to FIGS. 2-6, a process of forming an armor layer of a spoolable pipe will be described. In accordance with one or more embodiments of the present disclosure, reinforcement tape and fabric tape may be bonded and/or wound together to form segments of laminates. In accordance with one or more embodiments of the present disclosure, the laminate may be a single structural tape with a layer of reinforcement tape and a layer of fabric tape. Where the fabric tape is a prepreg, the tackier or higher adhesive side may be adhered to the reinforcement tape to form the laminate, and the non-tacky or less tacky side may be the other side of the fabric tape. Thus, the laminate may not substantially adhere to adjacent laminate wraps when spooled into a segment.

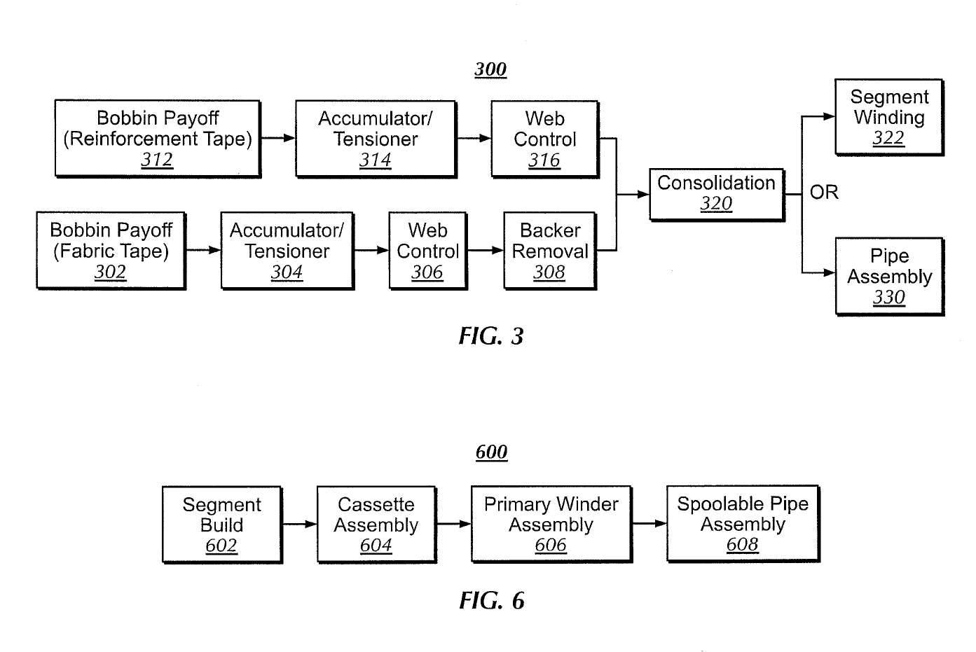

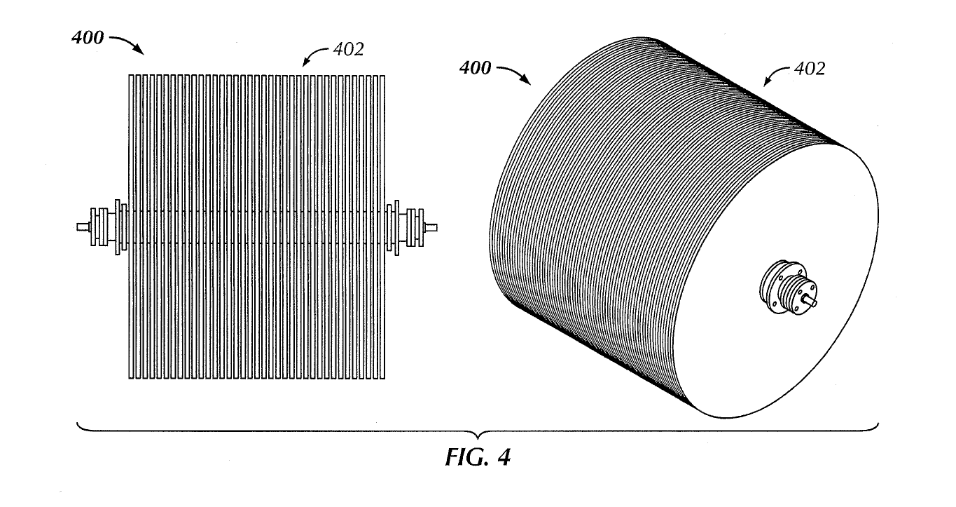

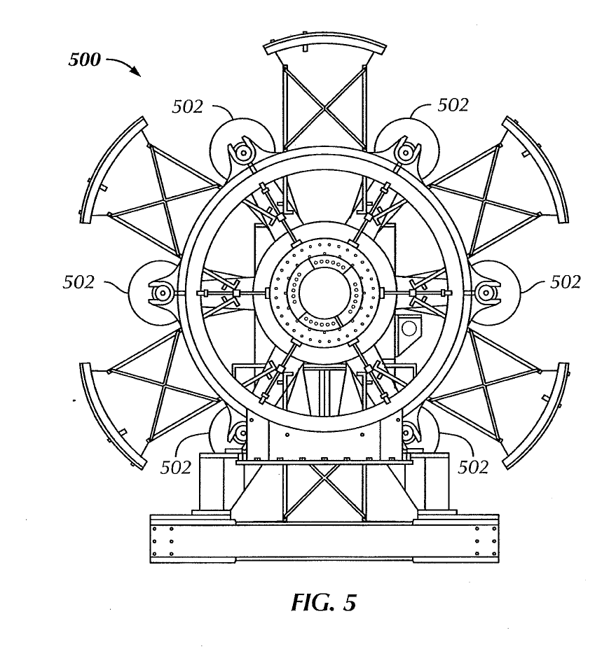

A laminate formation apparatus in accordance with one or more embodiments of the present disclosure is shown in FIG. 2, and a laminate formation process in accordance with one or more embodiments of the present disclosure is shown in FIG. 3. After formation, the segments may be stacked to form reinforcement stacks and may be applied to underlying layers of a pipe thereby forming an armor layer of the pipe. FIG. 4 shows alternate views of a cassette of segments of laminate in accordance with one or more embodiments of the present disclosure. FIG. 5 shows a primary winder in accordance with one or more embodiments of the present disclosure. FIG. 6 shows a process of manufacturing a spoolable pipe in accordance with one or more embodiments of the present disclosure.

Now referring to FIG. 2, an example of laminate formation in accordance with one or more embodiments of the present disclosure is shown. A spool 202 may store a winding of reinforcement tape 201. Spool 202 may be configured to dispense reinforcement tape 201 from a payoff 204 and reinforcement tape 201 may be unspooled and fed to an accumulator/tensioner 206. Reinforcement tape 201 may then be fed through a web control 208, and then to a consolidator 230, where the reinforcement tape 201 may be combined with a fabric tape 251 to form a laminate 231.

Similar to reinforcement tape 201, fabric tape 251 may be fed from a spool 252 through a payoff 254 and then fed through an accumulator/tensioner 256 and web control 258. After the fabric tape 251 is fed through the web control 258, a backer of the fabric tape may be removed by backer removal apparatus 260, exposing a side of the fabric tape having an adhesive. The fabric tape 251, without the backer, and the reinforcement tape 201 may then be combined at consolidator 230 to form laminate 231.

Laminate 231 may then be wound on a segment on segment winder 232 for storage or pre-pipe fabrication holding. Alternatively, laminate 231 may be applied directly to a pipe structure during manufacturing of the pipe after being consolidated or applied to the pipe structure at the point/time of consolidation. Accordingly, the laminates may be consolidated and immediately stacked on a pipe to form the reinforcement stacks of an armor layer.

Although shown with a single web control and accumulator/tensioner, those skilled in the art will appreciate that other configurations of tape control are possible without departing from the scope of the present disclosure. For example, tools to provide a twist or flip at various points during the feeding process may be used to create proper tension, positioning, and angle, along with additional and/or other equipment, without departing from the scope of the present disclosure.

Now referring to FIG. 3, a process 300 of forming a laminate in accordance with one or more embodiments of the present disclosure is shown. The laminate may be formed from a layer of fabric tape and a layer of reinforcement tape. As such, a fabric tape may be provided on a bobbin or other storage device, and a reinforcement tape may be provided on a bobbin or other storage device, each to be fed to a consolidation means for combining the two tapes to form a single laminate. Although shown as sourced from bobbins, those skilled in the art will appreciate that the fabric tape and reinforcement tape may be provided from any feeders and/or other sources known in the art without departing from the scope of the present disclosure.

At step 302 the fabric tape may be unspooled or provided from a payoff, such as a bobbin payoff. The fabric layer may then be fed through an accumulator and/or tensioner at step 304. Next, a web control may be provided at step 306. The accumulators, tensioners, and web controls, at steps 304 and 306, may allow for the tape to have proper tension, alignment, and position at a point of consolidation, touch-down, or application. At step 308 a backer of the fabric tape may be removed. As noted above, the fabric tape has two sides, one of which may have adhesive for bonding with a reinforcement tape. The adhesive side may have a backer to allow for proper storage of the fabric tape and to prevent the fabric tape from sticking to itself or accumulators, tensioners, web controls, and/or other elements and/or equipment during processing. After the backer is removed, the fabric tape may be fed to a consolidator at step 320.

Concurrently, at step 312, reinforcement tape may be provided from a payoff, such as a bobbin payoff. The reinforcement tape may also be fed through accumulators and/or tensioners at step 314 and fed through a web control at step 316. Because the reinforcement tape does not have an adhesive coating, the step of backer removal is not necessary for the reinforcement tape. Alternatively, those skilled in the art will appreciate that the reinforcement tape may have the adhesive and backer, and a backer removal may be used with the reinforcement tape, prior to consolidation, or both tapes may have adhesive and/or backers to be removed, without departing from the scope of the present disclosure. The reinforcement tape may then be fed to the consolidator at step 320.

At step 320, the fabric tape and the reinforcement tape may be consolidated. The consolidation allows for the fabric tape and the reinforcement tape to form a single structural element, a laminate. The tackiness or adhesive on one side of the fabric tape may allow for proper consolidation of the two tapes to form the laminate, bonding the fabric tape to the reinforcement tape. The consolidation at step 320 may be made by rollers or another device to apply a normal force to the laminate. In addition, heat or radiation may be applied to consolidate the laminate, or other known means of combining two tapes such that the two tapes are aligned and form a single laminate after consolidation.

In accordance with one or more embodiments of the present disclosure, the laminate may then be wound onto a segment using a segment winder, cassette, or other structure at step 322. A cassette is a collection of segments that are grouped together for the purpose of constructing a reinforcement stack of an armor layer when applied to the surface of a pipe during construction, see FIG. 4 and discussion below. The wound laminates may form segments of laminate material and may be stored, for example, on cassettes that may be used for feeding the segments to form a reinforcement stack of an armor layer of a spoolable pipe. Alternatively, the laminates may be fed onto a segment winder or cassette and then fed directly to form an armor layer of a spoolable pipe, without the need to be stored. Alternatively still, in accordance with one or more embodiments of the present disclosure, the consolidation may occur at the time of pipe assembly at step 330, eliminating the need for cassettes and/or storage.

As noted above, although the process herein described includes a single step of accumulator/tensioner and web control, more and/or other tape control mechanisms may be used without departing from the scope of the present disclosure.

Now, with reference to FIG. 4, multiple views of a cassette 400 in accordance with one or more embodiments of the present disclosure are shown. As shown in FIG. 4, multiple segments 402 may be installed on cassette 400. Moreover, those skilled in the art will appreciate that any number of segments may be installed on a cassette and in any configuration, without departing from the scope of the present disclosure.

In accordance with one or more embodiments of the present disclosure, cassettes may be installed on a primary winder to allow for formation of reinforcement stacks during manufacture of a spoolable pipe. For example, as shown in FIG. 5, a primary winder 500 is shown. Primary winder 500 may be installed with one or more cassettes 502. Although one embodiment of a primary winder is shown herein, those skilled in the art will appreciate that winders of various configurations may be used without departing from the scope of the present disclosure.

Now, with reference to FIG. 6, a process 600 of constructing a spoolable pipe in accordance with one or more embodiments is shown. At step 602, the process previously described with reference to FIGS. 2 and 3 is performed; the laminate may be formed in segments, or merely consolidated at the time of manufacture, depending on the preferred process. If consolidation is used to form segments on cassettes or other storage means, the segments may then be stored on a cassette at step 604. One or more segments of laminates may be stored on a single cassette. If more than one segment is wrapped on a single cassette, two sequential laminates may be bonded together to form a single, longer segment. Alternatively, the segments may not necessarily need to be bonded at the time of winding the segments on the cassettes; the non-bonded or joined segments may be bonded together during a bonding process of the pipe or at any other time without departing from the scope of the present disclosure.

Next, at step 606, one or more cassettes may be installed on a primary winder configured to pay off the segments from each of the cassettes installed on the primary winder. The primary winder may pay off the segments from the cassettes onto the surface of a spoolable pipe to form one or more reinforcement stacks composed of helical stacks of the segments of laminates.

During manufacture of a spoolable pipe, the laminates, whether installed as segments or directly from consolidation, may be applied to the underlying layer in one or more helical stacks of laminates. Each stack of laminates may form a reinforcement stack of an armor layer of the spoolable pipe. For example, laminates forming a first armor layer may be applied to an underlying layer such as an anti-extrusion layer that is wrapped around a core or liner of the spoolable pipe, as shown in FIG. 1A and FIG. 1B. Alternatively, if an anti-extrusion layer is not used, the laminates may be applied directly to a liner or other interior element, or may be applied to an anti-wear layer or other layer of the spoolable pipe. Subsequently applied armor layers may each be applied to an underlying layer which may be any layer of the spoolable pipe.

After the laminates are stacked and wrapped to form an armor layer of the spoolable pipe, the spoolable pipe may be passed through an oven to bond the laminates. The bonding process may allow for the prepreg matrix material in the fabric tape to bond adjacent laminates. Heating the prepreg in the laminate may result in the matrix material wetting the fabric in the prepreg more uniformly Further, the wetting may wet adjacent reinforcement tape surfaces so that additional heating or radiation and/or subsequent cooling may harden the matrix material and may bond the one or more fabric tapes and reinforcement tapes into a single structural reinforcement stack of the armor layer.

In accordance with one or more embodiments of the present disclosure, the reinforcement tapes may be bonded into reinforcement stacks to form the armor layers. The bonding process may allow for the laminates of the armor layers to bond and impart the necessary structural characteristics to the armor layer. Various bonding processes may be used without departing from the scope of the present disclosure, including, but not limited to, modular hydrothermal curing and steam curing. Further, alternative bonding processes are disclosed in Patent Application No. PCT/US11/27010 filed on Mar. 3, 2011, and entitled “Radiation Cured Reinforcement Stacks,” incorporated in its entirety herein by reference.

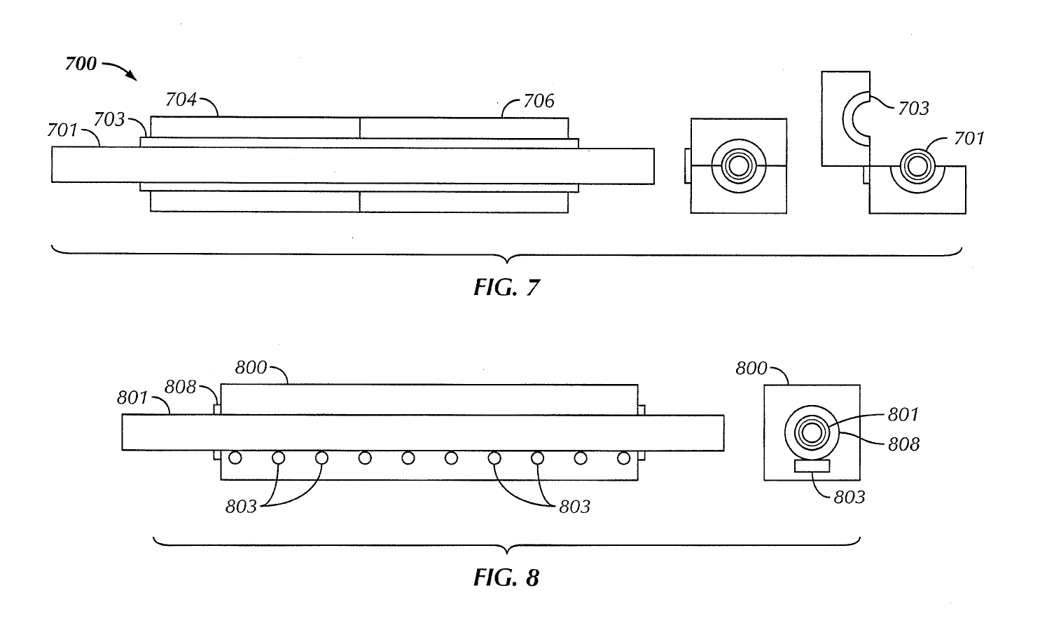

Referring now to FIG. 7, a modular hydrothermal curing unit 700 is shown. The spoolable pipe 701 may pass through cure units 704 and 706. Each of the cure units 704 and 706 may be water-filled and heated to curing temperatures. Cure units 704 and 706 may each be composed of a clamshell. The clamshell structure may allow for curing of segments of spoolable pipe 701. The clamshells of cure units 704 and 706 may include a low-friction flexible membrane 703 configured to isolate and seal the hydrothermal fluid within cure units 704 and 706.

As shown, the module hydrothermal cure units 704 and 706 may be designed to be used end-to-end to provide required curing temperatures and residency time. Multiple cure units may be used and set to different temperatures to produce controlled temperature ramping rates and cooling of the spoolable pipe 701.

The low-friction flexible membrane may allow for the spoolable pipe 701 to move through the cure units at production rates, thereby allowing the pipe to pass through the units without impeding the speed of production. Further, each cure unit may be equipped with an individual temperature controller or may be controlled by a master control unit, such as a programmable logic controller. Further, the cure units may be configured such that external recirculating and various heating systems may be used.

Alternatively, in accordance with one or more embodiments of the present disclosure, the spoolable pipe may be cured using steam curing. Referring now to FIG. 8, a spoolable pipe 801 may pass through a steam curing unit 800 along a conveyance means 803. Flexible seals 808 may be configured at either end of the steam curing unit 800 such that a proper fluid seal is created, and proper curing temperatures may be maintained. Although shown as a single steam curing unit 800, those skilled in the art will appreciate that more units may be used and each unit may be individually controlled for temperature and residency time. Steam may be provided to the steam cure unit 800 from an external boiler unit and may be controlled by solenoid valves. Alternatively, other methods of steam production and/or supply may be used without departing from the scope of the present disclosure.

Although two examples are provided herein with regard to the forming of reinforcement tapes into reinforcement stacks of the armor layers of a spoolable pipe, those skilled in the art will appreciate that other forming methods may be used without departing from the scope of the present invention.

In accordance with one or more embodiments of the present disclosure, for example a hoop-strength armor layer, the reinforcement stack may have tension stress in the fiber direction (along the length of the reinforcement stack) and have compressive stress through the thickness direction when under internal pressure load. The compressive stress through the thickness generates a tensile stress across the width of the stacks of the armor layer. The tensile capacity across the width may be controlled by the tensile capacity of the matrix material bonding the fibers of the reinforcement tapes, and, in accordance with one or more embodiments of the present disclosure, the tensile capacity may be increased by including a fabric tape in the formation of the laminates of the stacks of the armor layer.

Advantageously, in accordance with one or more embodiments disclosed herein, armor layers, including hoop strength and tensile strength armor layers, may have increased compressive strength in the reinforcement stacks that may comprise the armor layers. Prepreg materials in a fabric tape may provide fibers in a width direction, in addition to the longitudinal fibers of the reinforcement tape. The width direction fibers may increase the compressive strength of the laminates and the reinforcement stacks they form.

Moreover, use of a prepreg material may reduce the thickness and cost of production by automating the adhesive application process and allowing a minimalistic fabric layer to provide substantial compressive strength increases.

Furthermore, because of the high strength-to-weight ratio of the composite reinforcement material that composes the reinforcement tapes or laminates, flexible pipe, as disclosed herein, may be ideal for deepwater and ultra-deepwater service. In contrast to the flexible pipe as disclosed herein, traditional steel flexible pipe may have insufficient tension capacity at a hang-off location during deployment in deepwater and ultra-deepwater service.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

1. A method to manufacture an armor layer of a spoolable pipe, the method comprising:
forming one or more laminates;
wrapping the one or more laminates onto an underlying layer of the pipe,
wherein at least one of the laminates comprises at least one reinforcement tape and at least one fabric tape; and
bonding at least one of the one or more laminates to an adjacent laminate.

2. The method of claim 1, wherein the forming one or more laminates comprises:
unspooling at least one fabric tape and at least one reinforcement tape; and
consolidating the at least one fabric tape and the at least one reinforcement tape to form the one or more laminates.

3. The method of claim 2, further comprising:
running at least one of the tapes through at least one of a tensioner and an accumulator; and
running the at least one of the tapes through a web control.

4. (canceled)

5. (canceled)

6. The method of claim 1, wherein the at least one fabric layer comprises a prepreg material.

7. The method of claim 6, further comprising adhering a tackier side of the prepreg material to the reinforcement tape to form the one or more laminates.

8. The method of claim 6, wherein a matrix material flows through a non-tacky or less tacky side of the prepreg and bonds to the reinforcement tape of an adjacent laminate.

9. The method of claim 1, wherein the at least one fabric layer comprises fibers arranged in a chopped matt configuration.

10. The method of claim 1, wherein the at least one fabric layer comprises woven fibers.

11. The method of claim 1, further comprising winding one or more laminates onto a segment.

12. The method of claim 11, further comprising installing one or more segments onto a primary winder.

13. The method of claim 12, wherein the wrapping of the one or more laminates are fed from the primary winder.

14. The method of claim 1, further comprising bonding one or more of the laminates prior to wrapping the one or more laminates onto the underlying layer of the pipe.

15. The method of claim 1, further comprising bonding one or more of the laminates after wrapping the one or more laminates onto the underlying layer of the pipe.

16. (canceled)

17. (canceled)

18. A method to manufacture an armor layer of a spoolable pipe, the method comprising:
providing a plurality of reinforcement tapes having fibers oriented in a first direction; and
disposing at least one fabric tape between at least two layers of the plurality of reinforcement tapes,
wherein fibers of the at least one fabric tape are oriented in at least a second direction.

19. The method of claim 18, wherein the second direction is substantially perpendicular to the first direction.

20. The method of claim 18, wherein the fabric tape comprises a prepreg.

21. The method of claim 18, wherein the fabric tape comprises a chopped matt configuration of fibers.

22. The method of claim 18, wherein the fabric tape comprises woven fibers.

23.-27. (canceled)

28. An armor layer of a spoolable pipe, the armor layer comprising:
a plurality of reinforcement tapes comprising fibers oriented in a first direction,
wherein at least one of the plurality of reinforcement tapes comprises a plurality of fibers woven within the at least one reinforcement tape, and
wherein the woven fibers are oriented in at least a second direction.

29. The armor layer of claim 28, wherein the first direction and the second direction are substantially perpendicular to each other.

30.-58. (canceled)
